(19) United States
(12) Patent Application Publication
(10) Pub. No.: US 2015/0072814 A1
(43) Pub. Date: Mar. 12, 2015

(54) TENSIONING MECHANISM WITH DAMPING SENSITIVE TO TEMPERATURES

(71) Applicant: iwis motorsysteme GmbH & Co. KG, Munchen (DE)

(72) Inventors: Franz WACH, Munchen (DE); Renzo PERISSINOTTO, Munchen (DE)

(21) Appl. No.: 14/480,294

(22) Filed: Sep. 8, 2014

(30) Foreign Application Priority Data
Sep. 9, 2013 (DE) 102013014975.4

(51) Int. Cl. F16H 7/08

(52) U.S. Cl. CPC F16H 7/08
USPC 474/110

(57) ABSTRACT

A tensioning mechanism for tensioning an endless drive device such as, for example, a chain or a belt, is provided, with a tensioning device which can operatively engage with the endless drive device, a tensioning device seat in which the tensioning device is movably received, a pressure chamber being formed between the tensioning device and the tensioning device seat, a fluid inlet which opens into the pressure chamber, a fluid outlet exiting from the pressure chamber and a valve disposed in the fluid outlet. A tensioning mechanism is provided that avoids the drawbacks of known tensioning mechanisms and is, in particular, operable independently. It is provided for this that the valve is controlled automatically depending on temperature.

### CROSS-REFERENCE TO RELATED APPLICATION

This application claims priority to foreign German patent application No. DE 102013014975.4, filed on Sep. 9, 2013, the disclosure of which is incorporated by reference in its entirety.

### FIELD OF THE INVENTION

The present invention relates to a tensioning mechanism for tensioning an endless drive device, such as e.g. a chain or a belt, with a tensioning device which can operatively engage with the endless drive device, a tensioning device seat in which the tensioning device is movably received, a pressure chamber being formed between the tensioning device and the tensioning device seat, a fluid inlet which opens into the pressure chamber, a fluid outlet exiting from the pressure chamber and a valve disposed in the fluid outlet.

### BACKGROUND

Such tensioning mechanisms are also referred to as hydraulic chain tensioners and used, for example, in internal combustion engines where they are used for tensioning the timing chain of the camshaft drive. The chain tensioner is connected to the lubrication oil circuit and the lubricating oil serves as pressure fluid that is supplied to the chain tensioner via a fluid inlet and fluid outlet of the pressure chamber. The tensioning force of the chain tensioner is then generated by the pressure in the lubricating oil circuit. When retracting the chain tensioner piston, i.e. the tensioning device, into the seat, the oil pressure increases and a portion of the oil present in the pressure chamber flows through a gap between the seat and piston into the chain drive case.

The viscosity of the oil presently plays a significant role. The pressure, the viscosity and the temperature of the lubricating oil can vary considerably in the course of operation of the internal combustion engine. For example, the lubricating oil is very viscous in a cold internal combustion engine or the pressure in the lubricating oil circuit changes depending on the oil temperature and the rotational speed of the engine. When the oil temperature changes significantly, the damping properties of the chain tensioner also change. Internal combustion engines are usually operated in ranges between −40° C. and 120° C. The lower temperature limit is determined by environmental conditions when the engine is started and therefore depends on the region of operation. A common operating temperature of internal combustion units is at 120° C. Therefore, the range of change of the oil properties, in particular the viscosity, is very large and the damping properties of the chain tensioner are subject to significant changes from the start-up until reaching the operating temperature.

A chain tensioner is already known from DE 10 2011 016 664 A1 that takes into account such viscosity and therefore damping changes. The chain tensioner comprises a chain tensioner body and a tensioning piston which is movably received in a seat in the chain tensioner body. A pressure chamber is formed between the tensioning piston and the seat in the chain tensioner body. An oil inflow channel leads to the pressure chamber. Furthermore, an oil outflow channel is provided to drain the oil from the pressure chamber. A valve is disposed in the oil outflow channel that is connected to a controller for adjusting the damping properties of the chain tensioner according to the current operating conditions of the internal combustion engine.

A similar tensioning mechanism is known from DE 202 02 663 U1. This tensioning mechanism as well comprises a chain tensioner body in which a seat is formed for a tensioning piston. The tensioning piston is movably disposed in the seat. A pressure chamber is formed between the tensioning piston and the seat and is connected to a fluid outlet. A valve is disposed In the fluid outlet which opens or closes the fluid outlet. The valve is controlled in dependence of operating parameters such as the viscosity of the lubricating oil, the temperature, the supply pressure of the lubricating oil, the tension of the endless drive device and/or the acceleration or the stroke of the tensioning device or a tensioning bar.

In the tensioning mechanisms previously known, active-control valves are used that are actuated, for example, in an electro-mechanical, hydraulic, or electronic manner and controlled in response to recorded operating parameters. Active recording of the operating parameters, a connection to the control unit of the engine, and in most cases also a connection to a power supply is therefore required.

### SUMMARY OF THE INVENTION

It is therefore one object of the present invention to further develop the tensioning mechanisms previously known and to avoid the known drawbacks, for example, the need for external power supply.

It is according to the invention therefore provided that the valve disposed in the fluid outlet is automatically controlled in dependence of the temperature.

The valve operates independently of a control unit and is set in advance to the desired temperature ranges. Any separate measurement of temperature and any electronic control is not necessary. The tensioning mechanism according to the invention is thereby completely independent.

It can in a preferred embodiment be provided that the fluid outlet leads to the fluid inlet. The hydraulic fluid, i.e. generally the engine oil, is thereby returned from the high-pressure region to the low-pressure region. This leads to quantity savings of volume flow. This allows the required amount of engine oil to be less, smaller units can be implemented with all the associated advantages such as less required space and lower fuel consumption. At high piston extension speeds, the fluid outlet automatically becomes a second inlet for the high pressure region of the chain tensioner.

It can be provided according to yet another embodiment that a reverse flow preventer is disposed in the fluid inlet. For example, this can be a check valve. This makes it possible to set the damping properties of the tensioning mechanism more accurately by opening and closing the valve in the fluid outlet.

It can be provided in a particularly simple embodiment that the valve comprises an expansion material element. The expansion material element changes its volume depending on the temperature. This means that the expansion material element expands at a predetermined temperature and thereby acts upon the valve such that the switching state of the valve changes, e.g. from an open position to a closed position or from a closed position to an open position. Opening or closing the valve can thereby be achieved with the expansion material element when the temperature of the expansion material element changes. The valve therefore requires no external control, but changes its closure state automatically in dependence of the temperature.

Preferably, the valve can comprise a valve needle upon which the expansion material element acts. When the expansion material element expands, then it pushes the valve needle from a first switch position to a second switch position. The valve there passes from an open position to a closed position or from a closed position to an open position.

It can further be provided that the valve is designed such that the fluid outlet is open at low temperatures and is blocked at high temperatures. The valve needle of the valve is therefore at low temperatures disposed outside the fluid outlet. When the temperatures increase and exceed a certain value, then the expansion material element expands and pushes the valve needle into the fluid outlet. The fluid outlet is then blocked. This enables soft damping when the engine is cold a hard damping when the engine is warm.

It can also be provided that the valve is designed such that the fluid outlet is blocked at low temperatures and is open at higher temperatures. In this case, for example, the diameter of the valve needle can be reduced at a certain section. Above a certain temperature value the expansion material element then expands, the section of the valve needle with reduced diameter is introduced into the fluid outlet and the fluid outlet is thereby opened. When the engine is cold, hard damping is achieved therewith, and soft damping when the engine is warm.

It can be provided in a further embodiment that a gap is formed between the tensioning device and the tensioning device seat. Oil can flow through this gap between the tensioning device and the tensioning device seat. Damping of the tensioning mechanism can therewith also be adjusted.

### BRIEF DESCRIPTION OF THE DRAWINGS

The invention is further illustrated in more detail using the figures.

FIG. 1 shows schematic representations of the tensioning mechanism,

FIG. 2 shows a perspective view of the tensioning mechanism,

FIG. 3 shows an oblique sectional view through the rear portion of the tensioning mechanism with the valve,

FIG. 4 shows a first embodiment of the valve of the tensioning mechanism at low temperatures,

FIG. 5 shows the valve from FIG. 4 after reaching the trigger temperature,

FIG. 6 shows a second embodiment of the valve of the tensioning mechanism at a low temperature, and

FIG. 7 shows the valve from FIG. 6 after reaching the trigger temperature.

### DETAILED DESCRIPTION

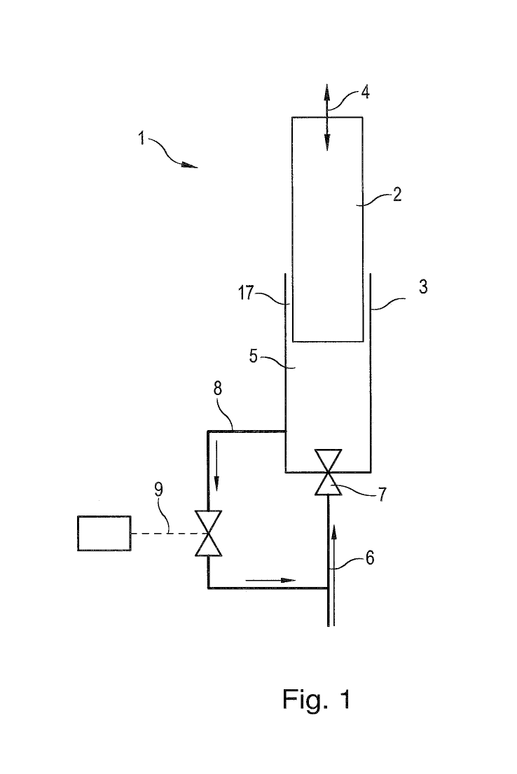

FIG. 1 shows a schematic representation of a tensioning mechanism 1 for tensioning an endless drive device, such as a chain or a belt. The tension mechanism 1 comprises a tensioning device 2 which is disposed in a tensioning device seat 3. The tensioning device 2 is movable to and fro in the tensioning device seat 3 in the direction of motion 4. A gap 17 is formed between the tensioning device 2 and the tensioning device seat 3. A pressure chamber 5 is formed by the tensioning device seat 3 and the tensioning device 2. A fluid inlet 6 opens into the pressure chamber 5. A check valve 7 is disposed in the fluid inlet 6 and prevents the fluid located in the pressure chamber 5 from flowing back into the fluid inlet 6.

The pressure chamber 5 is further connected to a fluid outlet 8. The fluid outlet 8 leads into the fluid inlet 6 so that a bypass flow is created. At high piston extension speeds, the fluid outlet automatically becomes a second inlet for the high pressure region of the chain tensioner. A valve 9 is disposed in the fluid outlet 8. The valve 9 is controlled automatically depending on the temperature and not connected to any external power supply or a control unit.

Preferably, the tensioning mechanism 1 is a hydraulic chain tensioner for an internal combustion engine. The tensioning device 2 is a tensioning piston acting upon a chain, for example, a timing chain of the internal combustion engine. A tensioning bar is preferably provided for this, which is brought to contact the chain and acts upon the tensioning piston 2. The fluid inlet 6 is connected to the engine housing and supplies engine oil to the pressure chamber 5. During retraction of the chain tensioner piston, i.e. the tensioning device 2, by a motion of the chain, the oil pressure in the pressure chamber 5 increases and a portion of the oil disposed in the pressure chamber 5 flows out from the pressure chamber 5. The oil can drain through the gap 17 or the fluid outlet 8. Depending on the position of the valve 9, hard or soft damping can be adjusted.

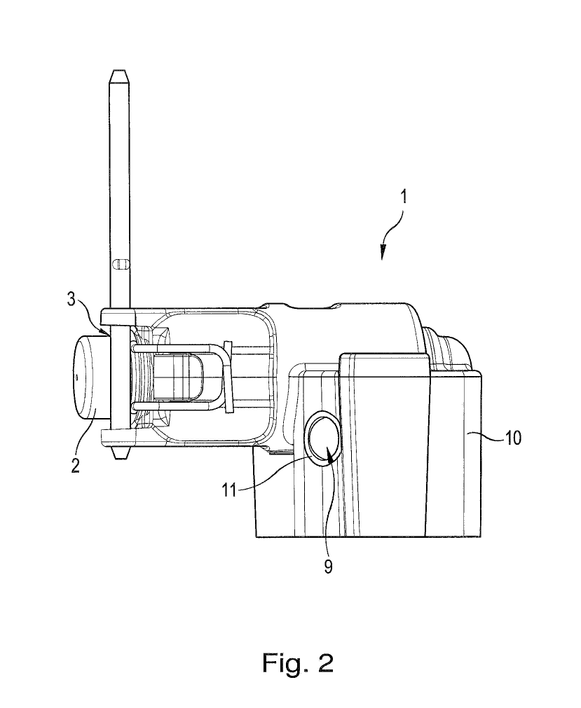

FIG. 2 shows the tensioning mechanism 1, i.e. the hydraulic chain tensioner, in a perspective view. The tensioning mechanism 1 comprises a housing 10 in which the tensioning device seat 3 is formed. The tensioning device 2 is disposed in the tensioning device seat 3. Furthermore, the fluid inlet 6 and the fluid outlet 8 are also formed in the housing. The housing 10 also comprises a seat 11 for the valve. 9

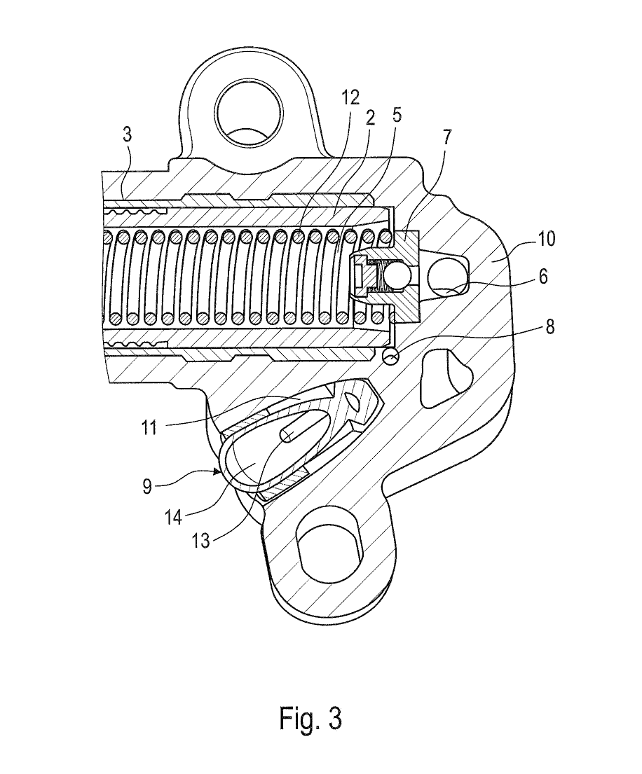

FIG. 3 shows an oblique sectional view through the housing 10 at the rear portion of the tensioning device 2. In the housing 10, the tensioning device seat 3 is formed in which the tensioning device 2 is movably received. The tensioning device 2 is pre-loaded by use of a spring 12. The pressure chamber 5 is formed between the seat 3 and the tensioning device 2. The fluid inlet 6 is also formed in the housing 10. The fluid inlet 6 in the rear portion of the tensioning device seat 3 opens into the pressure chamber 5. A check valve 7 is disposed there which prevents the fluid disposed in the pressure chamber 5 from flowing back into the fluid inlet 6. A fluid outlet 8 is further formed in the housing 10. The fluid outlet is also in fluid connection with the pressure chamber 5. The housing 10 further comprises a seat 11 in which the valve 9 is arranged. The valve 9 comprises a valve needle 13 that communicates with the fluid outlet 8 and can open or block the fluid outlet. The valve 9 further comprises an expansion material element 14 that acts upon the valve needle 13. The expansion material element 14 can be, for example, a wax cartridge. At a defined initial temperature, which is selected depending on the application, the wax of the wax cartridge is firm and the valve needle 13 is therefore in a first position. If the temperature exceeds a trigger temperature, the wax liquefies and thereby expands, whereby the valve needle 13 is pushed out from the valve 9 and to a second position in which it closes the fluid outlet 8.

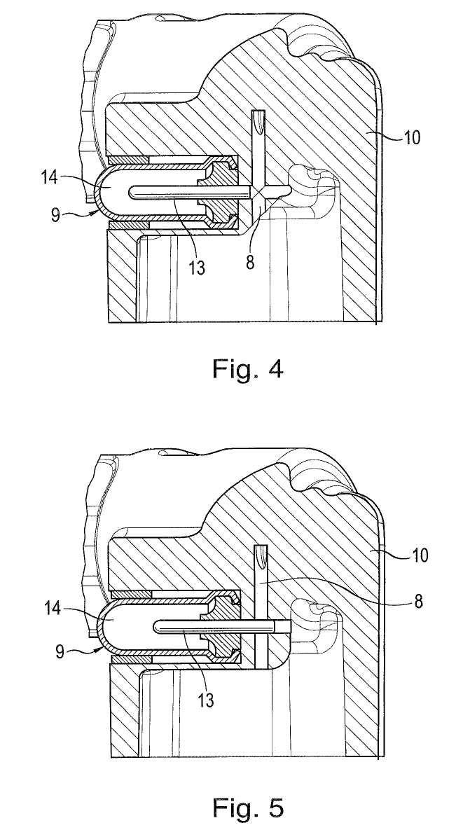

FIG. 4 shows a first embodiment of the valve 9 and the housing 10 in cross section. As already described, the valve 9 comprises a valve needle 13 and an expansion material element 14. The valve 9 is in FIG. 4 shown at a first low temperature which is below the trigger temperature. The expansion material element 14 is therefore in a first compressed state. The valve needle 13 is retracted into the valve 9 and clears the fluid inlet 8. The fluid inlet 8 is therefore in a flow-through position. When pressure is now applied onto the tensioning device 2, then the tensioning device 2 can move back into the tensioning device seat 3, the volume of the pressure chamber 5 is reduced and the engine oil located in the pressure chamber 5 can drain through the fluid outlet 8, preferably back to fluid inlet 6. In the embodiments shown in FIG. 4, soft damping of the tensioning mechanism 1 is therefore enabled at a low temperature, for example, at engine start-up.

FIG. 5 shows the valve 9 from FIG. 4. after reaching the trigger temperature. Upon reaching the trigger temperature, the expansion material element 14 expands and thereby pushes the valve needle 13 out from the valve 9 in the direction of the fluid outlet 8. The fluid outlet 8 is then closed by the valve needle 13. After reaching the trigger temperature, the engine oil located in the pressure chamber 5 can therefore no longer drain through the fluid outlet 8. When pressure is now applied onto the tensioning device 2, then the fluid located in the pressure chamber 5 can exit from the pressure chamber 5 only through the gap between the tensioning device seat 3 and the tensioning device 2. This realizes harder damping of the tensioning device.

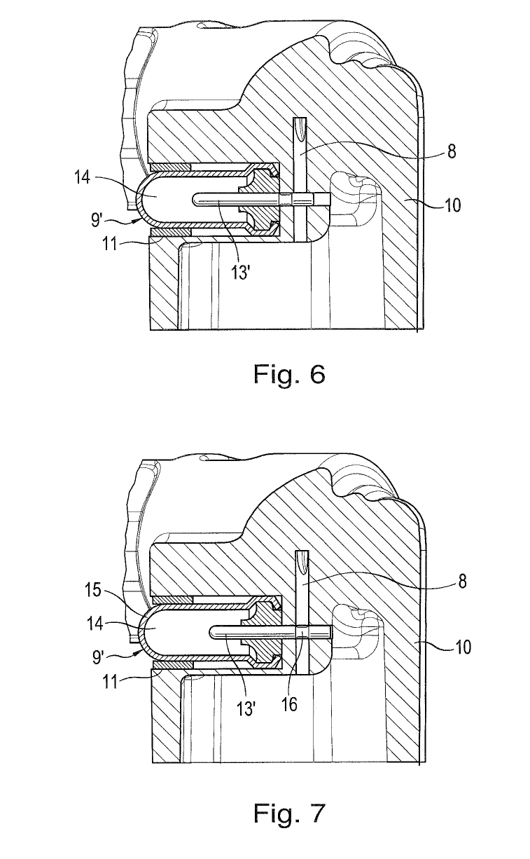

FIG. 6 shows a second embodiment of the valve 9. Herebelow only the differences shall be described, same components shall be denoted with same reference numerals. The valve 9 is again disposed in a seat 11 in the housing of the tensioning mechanism 1. The valve 9 likewise comprises a valve needle 13′ and an expansion material element 14. In FIG. 6 the temperature of the tensioning mechanism is below the trigger temperature of the expansion material element 14. The expansion material element 14 therefore does not apply any pressure onto the valve needle 13′, the valve needle 13′ is located in a retracted position. However, the valve 9 is designed such that the valve needle 13 in the retracted position protrudes into the fluid outlet 8 of the tensioning mechanism and closes the fluid outlet 8.

FIG. 7 shows the valve 9 from FIG. 6. after reaching the trigger temperature. The expansion material element 14 has expanded and pushed the valve needle 13′ out from the valve body 15. The valve needle 13′ is formed such that it has a tapered portion 16. The cross section of the valve needle 13′ is in portion 16 reduced. In the pushed-out state of the valve needle 13′, the tapered portion 16 is located in the fluid outlet 8. The fluid outlet 8 is thereby deblocked. The embodiment in FIGS. 6 and 7 is therefore designed such that hard damping is realized at low temperatures when the fluid outlet 8 is closed and soft damping at high temperatures.

### LIST OF REFERENCE NUMERALS

1 tensioning mechanism

2 tensioning device

3 tensioning device seat

4 direction of motion

5 pressure chamber

6 fluid inlet

7 check valve

8 fluid outlet

9 valve

10 housing

11 valve seat

12 spring

13,13′ valve needle

14 expansion material element

15 valve body

16 tapered portion

17 gap

1. A tensioning mechanism for tensioning an endless drive device, such as a chain or a belt, with a tensioning device which can operatively engage with said endless drive device, a tensioning device seat in which said tensioning device is movably received, a pressure chamber being formed between said tensioning device and said tensioning device seat, a fluid inlet which opens into said pressure chamber, a fluid outlet exiting from said pressure chamber and a valve disposed in said fluid outlet where said valve is automatically controlled depending on temperature,
wherein said fluid outlet leads to said fluid inlet.

2. The tensioning mechanism according to claim 1, wherein said fluid outlet leads to said fluid inlet.

3. The tensioning mechanism according to claim 1, wherein a reverse flow preventer is disposed in said fluid inlet.

4. The tensioning mechanism according to claim 1, wherein said valve comprises an expansion material element.

5. The tensioning mechanism according to claim 4, wherein said expansion material element acts upon a valve needle.

6. The tensioning mechanism according to claim 1, wherein said valve is designed such that said fluid outlet is open at low temperatures and is blocked at higher temperatures.

7. The tensioning mechanism according to claim 1, wherein said valve is designed such that said fluid outlet is blocked at low temperatures and is open at high temperatures.

8. The tensioning mechanism according to claim 1, wherein a gap is formed between said tensioning device and said tensioning device seat.
